(19) United States
(12) Patent Application Publication
(10) Pub. No.: US 2026/0005892 A1
(43) Pub. Date: Jan. 1, 2026

(54) METHOD AND SYSTEM FOR DELIVERING A MESSAGE TO ONE OR MORE RECEIVING TERMINALS

(71) Applicant: Kwok Wai Robert LEE, Flushing, NY (US)

(72) Inventor: Kwok Wai Robert LEE, Flushing, NY (US)

(21) Appl. No.: 19/073,473

(22) Filed: Mar. 7, 2025

(30) Foreign Application Priority Data
Jul. 1, 2024 (CN) 202410870791.7

(51) Int. Cl. H04L 12/18; H04W 4/06; H04W 68/00

(52) U.S. Cl. CPC H04L 12/189; H04W 4/06; H04W 68/00

(57) ABSTRACT

A method for transmitting a message to one or more receiving terminals. The method includes the steps of: broadcasting, by a server, a list containing respective identification information of one or more messages to multiple receiving terminals; making, by at least one of the multiple receiving terminals, a message request to the server based on the above list, wherein the message request includes identification information of one of the above one or more messages; and broadcasting, by the server, a requested message to the multiple receiving terminals. Such a method achieves an optimal balance between message broadcasting and resource on-demand.

### FIELD OF INVENTION

This invention in general relates to broadcasting of a message to one or more receiving terminals.

### BACKGROUND OF INVENTION

Broadcasting of digital messages refers to the distribution of data content to multiple recipients at once via any electronic mass communication network in a one-to-many model. Data content carried in such broadcasting may be presented in the form of text, audio or video, or a combination thereof. With the growth of wireless communication networks and Internet data networks, it has become common for computer terminals connected via the Internet to send and receive messages, and broadcast messages can be sent via wireless or wired methods such as short message service, multimedia messaging service, e-mail, etc.

Chinese patent application publication CN110035000A describes a method for filtering and processing broadcast messages at multiple receiving terminals based on a message label indicating content of the message and a category of the sender, thereby allowing receiving terminals to determine the relevance of the message before opening it. However, in the disclosure of the document, the sender (e.g., via a server) broadcasts all messages, regardless of whether any receiving terminal needs to receive and display these messages to its users (because the filtering is performed at the receiving terminal). While this approach ensures that any useful messages are sent, it also results in a waste of processing power on the server and/or network resources, as even those messages that are not needed by any receiving terminal are sent. Furthermore, the method of making the document publicly available does not guarantee the quality of the messages received by the receiving terminal. For example, in the event that part of the received message is missing or incorrect, the receiving terminal will not be able to display the received message correctly.

### SUMMARY OF INVENTION

Accordingly, the invention provides, in a first aspect, a method for transmitting a message to one or more receiving terminals. The method includes the following steps: broadcasting, by a server, a list containing respective identification information of one or more messages to multiple receiving terminals; making, by at least one of the multiple receiving terminals, a message request to the server based on the above list, wherein the message request includes identification information of one of the above one or more messages; and broadcasting, by the server, a requested message to the multiple receiving terminals.

In some embodiments, the step of broadcasting the list includes repeatedly broadcasting the list to the multiple receiving terminals.

In some embodiments, the step of broadcasting the list includes repeatedly broadcasting the list to the the multiple receiving terminals at a fixed time interval.

In some embodiments, the identification information includes a first hash value of one of the one or more messages.

In some embodiments, the first hash value corresponds to a header of one of the one or more messages.

In some embodiments, the identification information includes at least one of a content label and a sender label of one of the one or more messages.

In some embodiments, the step of broadcasting the list is carried out via a WLAN network.

In some embodiments, the step of requesting the message is carried out via the TCP/IP protocol.

In some embodiments, in the step of broadcasting the requested message, the requested message broadcast by the server includes a header and a message content. The header includes the identification message as described above.

In some embodiments, in the step of broadcasting the requested message, the requested message broadcast by the server includes a header and one of a plurality of message packages, where the plurality of message packages together form the message content. The header includes identification information for the message and a number for one of the plurality of message packets.

In some embodiments, in the step of broadcasting the requested message, the requested message broadcast by the server contains a header and one of the plurality of message packets. The header includes a first hash value and a number for one of the plurality of message packets. The first hash value represents identification information for the header. The plurality of message packets together form the message content.

In some embodiments, the method further includes, after the step of broadcasting the requested message, a step of verifying the received message from the server by at least one of the plurality of receiving terminals.

In some embodiments, the method further contains, in response to the result of the step of verifying the received message from the server being a failure, a step of requesting the server to send the received message again by at least one of the plurality of receiving terminals.

In some embodiments, in the step of broadcasting the requested message, the requested message broadcast by the server also includes a second hash value which corresponds to the message content. The step of verifying the received message from the server includes calculating a hash value of the message content in the received message by at least one of the plurality of receiving terminals and comparing it with the said second hash value.

In some embodiments, the step of broadcasting the requested messages contains: receiving, by the server, respective message requests from two or more of the multiple receiving terminals; determining, by the server, a priority for the received multiple message requests; and broadcasting first, by the server, the messages corresponding to the message requests with a higher priority.

According to another aspect of the invention, there is provided a system for delivering messages to one or more receiving terminals. The system includes a server, which is conFig.d to: broadcast, to the one or more receiving terminals, a list comprising respective identification information of one or more messages; receive, from at least one of the one or more receiving terminals, a message request to the server based on the above list, the message request comprising identification information of one of the one or more messages; and broadcast, to the one or more receiving terminals, the requested message.

As can be seen, the methods and systems provided in various embodiments of the present invention can simultaneously achieve a wide coverage of the broadcast and an efficient use of the server and/or network resources. In particular, in one preferred embodiment, the content of the initial broadcast is only a list of indexes of the actual messages to be broadcast, and the data size of such a list is very small compared to the actual messages. Within the broadcast range, if any receiver receives the list and is interested in one or more messages contained therein, the receiver may send a request to the server, and the server will then broadcast the corresponding messages. In this way, if no one is interested in a message at all (i.e., no request is made), the server will not waste resources broadcasting it. On the other hand, as long as at least one receiver requests it, the server will broadcast the corresponding message, and all receivers (even if they have not made a request) will be able to receive it. Thus, this method of “one person demanding it, multiple persons receiving it” achieves an optimal balance between message broadcasting and resource provisioning on demand. In addition, the above method does not affect the filtering of messages at the receiving end, that is, each receiving end can filter and process the broadcast message at the receiving end based on the identifying information such as the message ID indicating the content of the message and the sender ID, thereby allowing these recipients to determine the relevance of the message before opening the message.

The above summary is neither intended to define the invention of the present application (which shall be subjected to the claims), nor to limit in any way the scope of the invention.

### BRIEF DESCRIPTION OF FIGS.

The foregoing and further features of the present invention will be apparent from the following description of embodiments which are provided by way of example only in connection with the accompanying FIGS., of which:

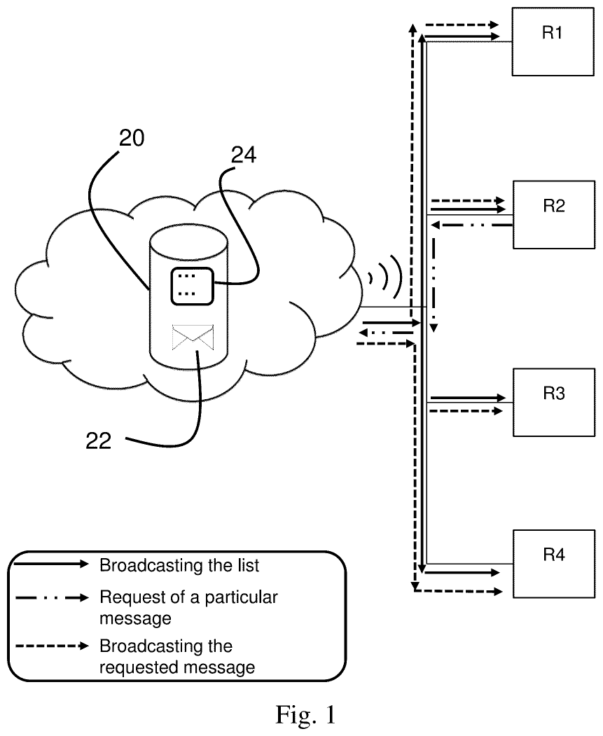

FIG. 1 shows the structure of a system for broadcasting a message to multiple receiving terminals according to a first embodiment of the present invention, as well as an example signal transmission direction.

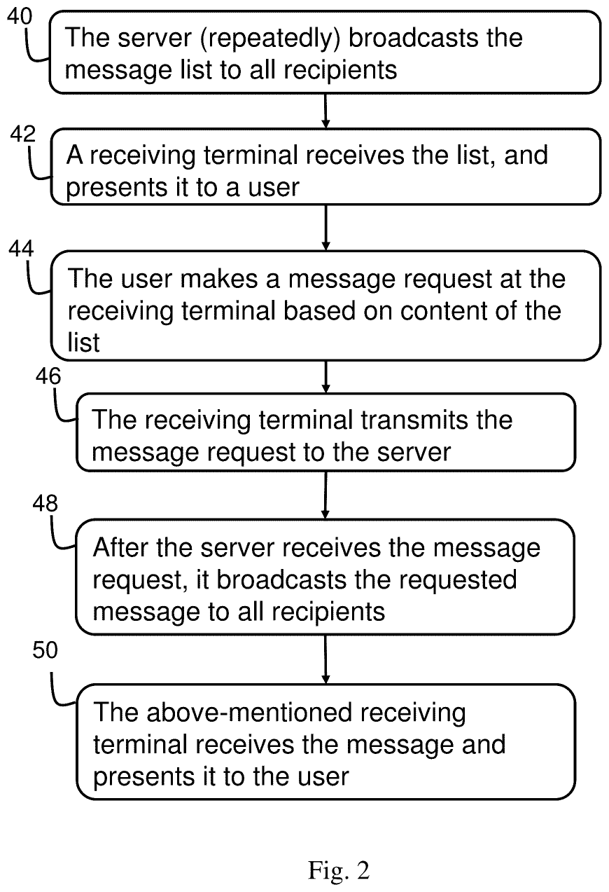

FIG. 2 is a flow chart of the method steps associated with the exemplary signal transmission direction in FIG. 1.

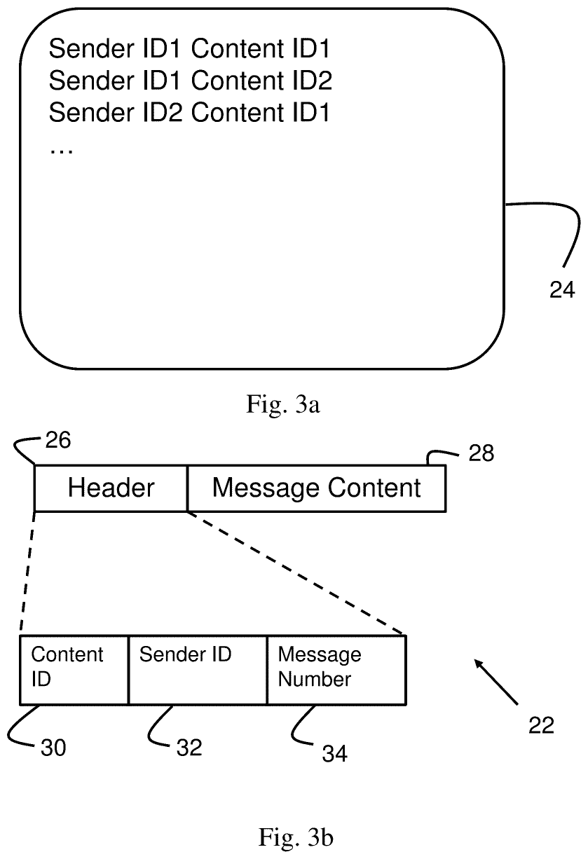

FIG. 3a shows the format of a message list according to an embodiment of the invention.

FIG. 3b shows the data structure of a message according to an embodiment of the invention.

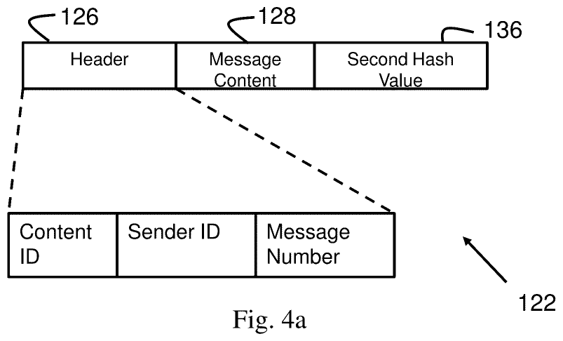

FIG. 4a shows the data structure of a message according to another embodiment of the invention.

FIG. 4b shows a method for verifying a received broadcast message in relation to the data structure of the message in FIG. 4a.

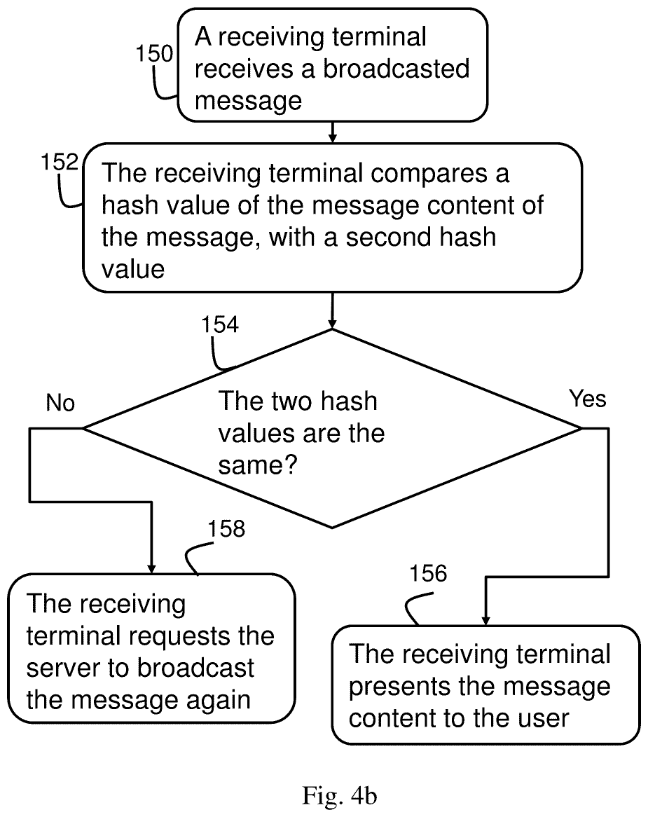

FIG. 5 shows the data structure of a message according to another embodiment of the invention.

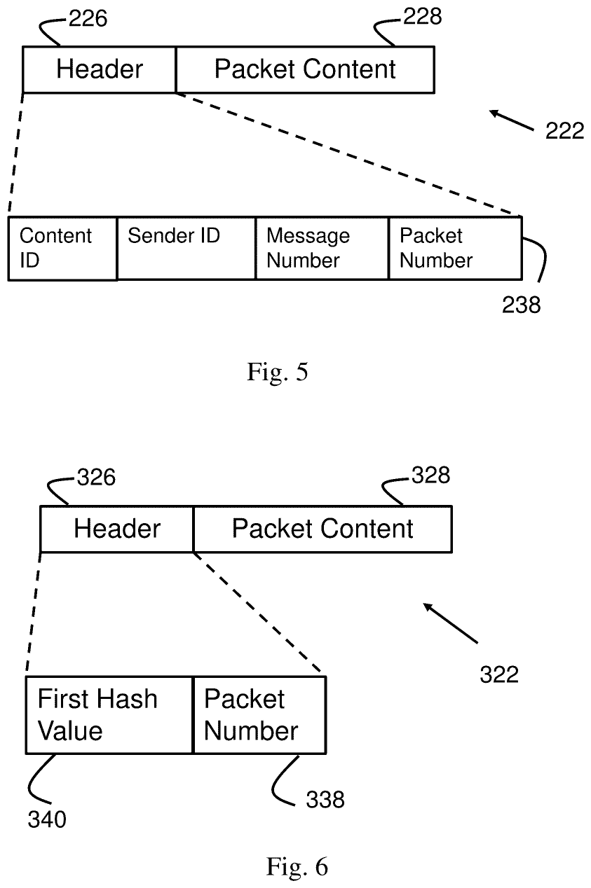

FIG. 6 shows the data structure of a message according to another embodiment of the invention.

In the description and the drawings, similar numerals designate similar parts in the several embodiments described.

### DETAILED DESCRIPTION OF PREFERRED EMBODIMENTS

Embodiments of the invention use a method for selectively broadcasting a message by having the receiving terminal request the specific message from the server. Additional different advantages and benefits provided by the embodiments of the invention are readily apparent from the following description.

For example, certain terms are used in the description and claims to refer to specific components. It should be understood by those skilled in the art that the same components may be referred to by different names by hardware manufacturers. The description and claims do not use such differences in names as a means of distinguishing the components, but rather use the functions of the components as the criterion for distinction. For example, the term “comprising” is used throughout the description and claims as an open term and should be interpreted as “including, but not limited to”. “Roughly” means within an acceptable error range, and a person skilled in the art can solve the technical problem described within a certain error range and basically achieve the technical effect described.

Unless otherwise defined, technical terms or scientific terms used herein shall have the ordinary meaning understood by a person of ordinary skill in the art to which the invention belongs. The use of the terms ‘first,’ ‘second,’ and the like in the description and claims of the patent application for this invention does not indicate any order, quantity, or importance, but is only used to distinguish different components. Similarly, words like “one” or “a” do not indicate a limitation on the quantity but rather indicate the existence of at least one.

In the following claims and description of the invention, unless the context requires otherwise due to the language used or necessary implication, the word “comprising” and its variations are used in the sense of including, i.e. designating the presence of the said features, but not excluding other features that exist or are added in various embodiments of the invention.

FIG. 1 shows a first embodiment of the invention, which illustrates a system for transmitting a message to one or more receiving terminals. The system contains a server 20, which is suitable for broadcasting data. The data in question may be, for example, messages 22, including but not limited to text, images, videos or a combination thereof. Alternatively, the data may also be a packet of the message, i.e. a small segment after splitting a larger data file. Furthermore, the data that the server 20 can broadcast may also be a list 24, which does not contain any specific message content, but summary information about one or more messages, each summary information including identification information of the corresponding message. In FIG. 1, it is shown that the server 20 can broadcast the message 22 or the list 24 to multiple recipients R1, R2, R3, R4. Note that the broadcast between the server 20 and the recipients R1, R2, R3, R4 can be carried out either by the server 20 via a wired connection or wirelessly, which is represented in FIG. 1 by the connection line and the wireless signal symbol, respectively. In one specific embodiment, the wired connection is a local area network (LAN) or a powerline network. In another specific embodiment, the wireless broadcast is carried out via WLAN multicast/groupcast or using WLAN UDP. As is known to those skilled in the art, WLAN can be based on Wi-Fi or other wireless communication technologies such as cellular networks, Bluetooth, ZigBee, etc.

In one specific embodiment, the server sends a message to all recipients in the network simultaneously via the broadcast address in the WLAN. For example, in a network using the TCP/IP protocol, the broadcast address is the IP address with a host ID segment of all 1s, and a message sent to this address will be delivered to all recipients involved in the host ID segment. For example, for the network segment 10.1.1.0 (255.255.255.0), the broadcast address is 10.1.1.255 (255 equals to the binary number 11111111). When a message is sent with the destination address 10.1.1.255, it will be distributed to all recipients on the network segment. Thus, broadcasting a message via a broadcast address enables all recipients to receive the message simultaneously via a single broadcast from the server. This greatly improves the efficiency of the broadcast.

Now, in combination with the flowchart in FIG. 2, the method for transmitting a message to one or more receiving terminals using the system in FIG. 1 is described. FIG. 1 shows with different arrows the direction of signal/data transmission between the server and multiple recipients R1, R2, R3, R4 in an example. First, the method begins with Step 40, in which the server 20 broadcasts a list 24 comprising identification information for multiple messages to multiple recipients R1, R2, R3, R4, as indicated by the solid arrows in FIG. 1. This broadcasting of the list 24 may be done once or multiple times (i.e. repeated broadcasting) to ensure that any later newly added recipient joining the broadcast range (e.g. a new receiving terminal that has just been switched on or that has moved from an area with no wireless signal to an area with such a signal) also receives the list 24. In a preferred embodiment, the server 20 repeatedly broadcasts the list 24 at a fixed time interval (e.g. once per minute).

As mentioned above, the list 24 does not include any message content (i.e. the main content of the messages to be broadcast). Instead, as shown most clearly in FIG. 3a, in one example the list 24 contains multiple entries, each of which is summary information for a different message. In this example, the summary information comprises a sender ID for the particular message, and a content ID for the message, which can be used to identify the particular message. The sender ID is used to distinguish between the sources or providers of different messages (not shown in FIG. 1), for example, “Sender ID 1” and “Sender ID 2” in FIG. 3a indicate that the messages come from different senders. Note that the sender here does not necessarily equate to server 20, but can be the subject that connects to the server 20 and provides the message to the latter, such as an advertiser, a government department, etc. In this case, the server 20 is able to accept and store messages from different senders and is configured to broadcast them upon request, as will be described in more detail later. The sender ID may be either a number/code or the full name of the sender (e.g. “xx Lanzhou beef noodles”). In the case of a number/code, the receiving terminal that receives the list 24 can identify the corresponding full name of the sender based on the number/code (e.g., by querying a database), thereby indicating to the user of the receiving terminal the sender of the message in the list. In some embodiments, the server 20 itself can be the sender, for example when the telecommunications provider operating the server 20 wants to broadcast information about disruptions to other telecommunications services or commercial offers, etc.

On the other hand, the content ID of a message is a short message that is used to distinguish between different messages from the same sender, in particular to indicate the content of the message. For example, the content ID could be “today's food offer” or “weather forecast”. The receiving terminal that receives the broadcasted list 24 is able to present the content ID to the user of the receiving terminal, who can thus find out whether the messages in the list are of interest. The presentation of the content IDs in the list 24 to the users does not necessarily have to be done by means of a display (e.g. by means of a display provided on the receiving terminal), but can also be done by other means, such as sound, or even VR (virtual reality), AR (augmented reality), etc. The action of the receiving terminals to present the received the list 24 to their respective users is carried out in Step 42 of FIG. 2.

In FIG. 2, after receiving and presenting to its user the list 24, one or more of all the recipients may be interested in one or more messages in the list. Then, in Step 44, the one or more recipients may make a message request to the server 20. For example, the receiving terminal may have a display and, after receiving the list 24, display the contents of the list 24 on the display. After reading the options provided by the list 24 for the different messages, the user can enter a signal at the receiving terminal via any input device such as a keyboard, keypad, touchscreen, etc. Alternatively, the user may also provide the input signal by voice (e.g. a smart voice assistant). The receiving terminal then sends the identification information of the message requested by the user corresponding to this input signal as a message request to the server 20 in Step 46, and the latter can then broadcast the corresponding message to the recipient according to the message request. The receiving terminal sends a message request to the server 20, which in one embodiment can be via TCP/IP, i.e. the receiving terminal first establishes a point-to-point connection with the server 20 via TCP/IP and then sends the message request to the server 20. In the case of more than one receiving terminal wanting to request a message, they each establish a point-to-point connection with the server 20 individually.

As an example, FIG. 1 shows the situation where, after the server 20 has broadcast the list 24, the recipient R2 is interested in a message from the list. In Step 46 above, the receiving terminal of the recipient R2 sends a message request to the server 20, as indicated by the dotted arrow in FIG. 1. The message request includes identification information for the requested message, including the sender ID and content ID as described above. After the server 20 receives the message request, it will transmit the requested message to all receivers within the broadcast range in Step 48, as shown by the dashed arrow in FIG. 1, regardless of whether these receivers have sent a message request for the message. In the example shown in FIG. 1, Step 48 means that the requested message is broadcast to all recipients R1, R2, R3, and R4, even though R1, R3, and R4 did not make a message request. This is because when broadcasting, the server 20 treats all R1, R2, R3, and R4 as a group, and therefore performs the action of “broadcast to everyone when one person requests”. In other variations of embodiments of the present invention, it is also possible to assign multiple recipients to different groups, so that a message requested by a recipient in a group is only broadcast to all recipients in that group. After Step 48, in Step 50 the receiving terminal presents the received message to the respective user, for example by display, sound, vibration, or other means.

Assuming that in the example shown in FIG. 1, one or more other recipients in addition to recipient R2 also request the same message as recipient R2, then the server 20 can broadcast the requested message only once to satisfy the requests of these recipients at the same time. In other variations, the server 20 can repeatedly send a requested message, for example at regular intervals over a fixed period of time (for example, once every minute for 10 minutes). On the other hand, if none of the recipients R1, R2, R3, and R4 in the example shown in FIG. 1 requests the message, then the server 20 will not receive any message request, and therefore the server will not perform any broadcasting action to save its processing resources and network bandwidth.

In the method shown in FIGS. 1-2, the example used assumes that only receiver R2 has made a message request for a message. However, a person skilled in the art should understand that in a variation of the embodiments of the present invention, requests for different messages may also be made by different receivers at the same time. In this case, the server may adopt different strategies, for example, assigning different priorities to the message requests from the receivers according to their own attributes, and the requests from the receivers with higher priorities will be processed preferentially (i.e., the requested messages will be broadcast preferentially). For example, some recipients may be more important, such as VIP customers. Alternatively, the priority may be based on the sender or content of the requested message, for example, emergency messages from the government have the highest priority (for example, when someone requests real-time disaster information). In addition, if advertisement is sent through the messages, the message provided to the server by the sender who has paid more for the advertisement will be broadcast with priority when there is a message request for multiple messages at the same time.

FIG. 3b shows an exemplary data structure of a message 22 (note that it is not a list 24) broadcast by the server 20. The message 22 contains a header 26 and a message content 28. The header 26 further includes a content ID 30, a sender ID 32 and a message number 34. The content ID 30 and the sender ID 32 can be the same as the corresponding entries in the list 24 shown in FIG. 3a. The message number 34 means that there may be multiple messages for the same sender ID and the same content ID, and they are numbered accordingly. For example, for the same message request, the server 20 may have multiple different messages to send, and they may be assigned different message numbers. For example, for a message request related to a telecommunications service, it may be necessary to send several messages, respectively regarding a first service offer, a second service offer, service commitment, etc., and their message numbers may be 1, 2, 3, etc.

FIG. 4a shows a variation of the above embodiment. Specifically, compared with the data structure of the message shown in FIG. 3b, the message 122 in FIG. 4a additionally includes a second hash value 136 in addition to the header 126 and the message content 128. The second hash value 136 corresponds to the message content 128 and is generated by the server by inputting the message content 128 into a hash algorithm, and is therefore unique. The hash algorithm that the server can use is not limited by the present invention and is well known to those skilled in the art, so it will not be described in detail here. The second hash value is included in the message 122 to facilitate the receiving terminal's verification of the integrity of the message 122 after receiving the broadcasted message 122. Specifically, the verification process is shown in FIG. 4b. In particular, in Step 150, a receiving terminal receives the broadcasted message 122 (the broadcasting process can be similar to that shown in FIG. 2 and will not be described in detail here). Then, in Step 152, the receiving terminal performs a hash algorithm on the message content 128 of the message 122 and compares it with the second hash value 136 included in the message 122. The hash algorithm used here should be the same as the algorithm used by the server to calculate the second hash value 136 mentioned above (e.g. by prior agreement between the server and the recipient). In Step 154, the receiving terminal determines whether the calculated hash value is the same as the second hash value 136 included in the received message 122. If they are the same, this indicates that the message content 128 in the message 122 sent by the server has been received intact and has not been corrupted during transmission (broadcast). Therefore, the receiving terminal can then present the message content 128 of the message 122 to the user in Step 156. However, if the receiving terminal determines in Step 154 that the two hash values differ, this means that the message content 128 of the message 122 sent by the server was not received completely. In this case, the receiving terminal will request the server to broadcast message 122 again in Step 158. This verification of the hash value ensures that the receiving terminal receives and displays the correct message content to the user.

FIG. 5 shows another variation of the above embodiment. Specifically, compared to the data structure of the message shown in FIG. 3b, the message 222 in FIG. 5 does not include a complete message content, but rather the content of one of multiple packets of the message content, i.e., packet content 228. Splitting a complete message content into multiple packets is useful for message contents with large data sizes, because due to the limitations of the broadcasting protocol, it may not be possible to broadcast a message content larger than a certain data size at one time. In addition, message contents with a large data size may also be more susceptible to data loss and errors during the broadcast process. By using packets, the fault tolerance of the message content reception is greatly improved. Of course, if the message content itself is not large, for example only a few bytes, then there is no need to use the packet format. In order to adapt to broadcasting in packet format, in the header 226 of the message 222, the packet number 238 is also recorded, which indicates the number of a packet (for example, “⅕”, which represents the first of a total of 5 packets). After a receiving terminal has received all the packets of a complete message content via multiple broadcasts, the receiving terminal can combine these packets in sequence according to the packet number 238 to form the complete message content and present it to the user. In addition, although not shown in FIG. 5, the message 222 containing the packet content 228 can also include the second hash value in FIGS. 4a-4b to help the receiving terminal verify whether the packet content 228 has been received completely. In addition, the message 222 containing the packet content 228 may be repeatedly broadcast by the server, either because the reception was incomplete (and therefore a receiving terminal requests it again) or because the server actively broadcasts it multiple times.

FIG. 6 shows another variation of the above embodiment. Specifically, compared to the data structure of the message shown in FIG. 5, the header 326 of the message 322 in FIG. 6 does not include the complete data content such as the content ID, sender ID, and message number, but rather these data contents are calculated by a hash algorithm to a first hash value 340, and the header 326 only includes the first hash value 340 and the packet number 338 (which is similar to the packet number described in FIG. 5). Compressing the rest of the header 326 into the first hash value 340 can help further reduce the data size of the broadcasted message based on the broadcasted packet content (rather than the complete message content). Accordingly, the identification information of each message in the list previously broadcasted by the server can include a hash value in addition to the sender ID and content ID. After the receiving terminal receives message 322 containing the first hash value 340, the receiving terminal can compare the hash values in the list with the first hash value 340. If the two match, the receiving terminal can directly restore the first hash value 340 in the message 322 to the identification information of the corresponding message in the list, thereby obtaining the complete message 322.

It should be noted that the above embodiments all focus on the process of “on-demand broadcasting” of messages between the server and the receiving terminal. However, on the receiving terminal itself, the received broadcast messages can be further processed in any desired manner. For example, the receiving terminal can filter the incoming broadcast messages according to its own needs, such as according to the sender identification information (i.e., the sender ID) and/or the attributes of the message (i.e., the content ID). If a received broadcast message is determined to meet the filter criteria based on one or more of the above, the receiving terminal will discard the received broadcast message. Otherwise, the received broadcast message will be further processed by the receiving terminal and the message content of the broadcast message will be provided to the user of the receiving terminal. Each receiving terminal may have filter criteria set by their respective users. In addition, the content ID can be used to indicate the type of display of the message, e.g. as a global or local type of display. In one example, if it is a global type of display, all receiving terminals within the receivable range of the broadcast communication network will receive the broadcast message and display the message content on their respective displays, unless the respective users have prohibited the display of the broadcast message on these receiving terminals according to the respective filtering criteria of these receiving terminals. In the case of a local display type, only selected receiving terminals located within a predetermined range (manually specified and smaller than the receivable range) of the broadcast communication network are able to receive the broadcast message and display the message content on their respective displays, but each user can still prohibit these receiving terminals from displaying these broadcast messages according to the respective filtering criteria of these receiving terminals. The above method of filtering broadcast messages at the receiving terminal can be implemented by software or hardware. In the case of software implementation, the corresponding software code can be stored in a memory unit and executed by a processor. The memory unit can be implemented within or outside the processor.

It should be understood that methods and systems according to exemplary embodiments of the invention can also be implemented in whole or in part by a computing system, using any suitable computing system architecture. This would include stand-alone computers, networked computers and dedicated hardware devices. The terms “computing system” and “computing device” are used, and these terms are intended to cover any suitable construction of computer hardware capable of performing the above functions.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A method for transmitting a message to one or more receiving terminals, comprising steps of:
a) broadcasting, by a server, a list comprising respective identification information of one or more messages to multiple receiving terminals;
b) making, by at least one of the multiple receiving terminals; a message request to the server based on the list; the message request comprising the identification information of one of the one or more messages; and
c) broadcasting, by the server, a requested message to the multiple receiving terminals.

2. The method according to claim 1, wherein Step a) comprises repeatedly broadcasting the list to the multiple receiving terminals.

3. The method according to claim 2, wherein Step a) comprises repeatedly broadcasting the list to the multiple receiving terminals at a fixed time interval.

4. The method according to claim 1, wherein the identification information comprises a first hash value of the one of the one or more messages.

5. The method according to claim 4, wherein the first hash value corresponds to a header of the one of the one or more messages.

6. The method according to claim 1, wherein the identification information comprises at least one of a content ID and a sender ID of the one or more messages.

7. The method according to claim 1, wherein Step a) is carried out via a WLAN network.

8. The method according to claim 1, wherein Step b) is carried out via a TCP/IP protocol.

9. The method according to claim 1, wherein in Step c), the requested message broadcasted by the server comprises:
d) a header; and
e) a message content;
wherein the header comprises the identification message.

10. The method according to claim 1, wherein in Step c), the requested message broadcasted by the server comprises:
f) a header; and
g) one of a plurality of message packets; the plurality of message packets together forming the message content;
wherein the header comprises the identification message and a number of the one of the plurality of message packets.

11. The method according to claim 1, wherein in Step C), the requested message broadcast by the server comprises:
h) a header including a first hash value; the first hash value representing identification information corresponding to the header; and
i) one of a plurality of message packets; the plurality of message packets together forming the message content;
wherein the header further comprising a number of the one of the plurality of message packets.

12. The method according to claim 9, further comprising, after Step c), a step of verifying the received message from the server by at least one of the plurality of receiving terminals.

13. The method according to claim 12, further comprising the step of requesting the server to send the received message again by at least one of the plurality of receiving terminals, in response to the result of the step of verifying the received message from the server being a failure.

14. The method according to claim 12, wherein in Step c), the requested message broadcast by the server further comprises a second hash value which corresponds to the message content; the step of verifying the message received from the server comprising calculating, by at least one of the plurality of receiving terminals, a hash value of the message content of the received message and comparing the hash value of the message content with the second hash value.

15. The method according to claim 1, wherein Step c) comprises:
j) receiving, by the server, respective message requests from two or more of the plurality of receiving terminals;
k) determining, by the server, priorities for the received plurality of message requests;
l) broadcasting first, by the server, the message corresponding to the message request with a higher priority.

16. A system for delivering a message to one or more receiving terminals, comprising a server, the server conFig.d to
a) broadcast, to one or more receiving terminals, a list comprising respective identification information of one or more messages;
b) receive, from at least one of the one or more receiving terminals, a message request to the server according to the list, the message request comprising the identification information of one of the one or more messages; and
c) broadcast, to the one or more receiving terminals, the requested message.
